(19) United States
(12) Patent Application Publication
(10) Pub. No.: US 2025/0070547 A1
(43) Pub. Date: Feb. 27, 2025

(54) ELECTRICAL PROPULSION SYSTEM FOR AN AIRCRAFT

(71) Applicant: SAFRAN ELECTRICAL & POWER, BLAGNAC CEDEX (FR)

(72) Inventors: Jérôme VALIRE, BLAGNAC CEDEX (FR); Quentin CORNU, BLAGNAC CEDEX (FR)

(21) Appl. No.: 18/724,689

(22) PCT Filed: Dec. 26, 2022
(86) PCT No.: PCT/FR2022/052507

§ 371 Date: Jun. 27, 2024

(30) Foreign Application Priority Data
Dec. 27, 2021 (FR) 2114560

(51) Int. Cl. H02H 7/12; B64D 27/35

(52) U.S. Cl. CPC H02H 7/1213; B64D 27/35

(57) ABSTRACT

An electrical propulsion system for an aircraft includes a central bus and a plurality of branches, each branch having at least one electrical power source, at least one electric propulsion device, and a branch bus, connected to each source and to each propulsion device of the branch. Each branch includes a DC/DC voltage converter connecting the branch bus to the central bus, said DC/DC voltage converter being configured to galvanically isolate said branch bus from the central bus.

### TECHNICAL FIELD OF THE INVENTION

The invention relates to an electrical propulsion system for an aircraft. Such a system is in particular installed on an aircraft with purely electric propulsion, for example an airplane.

### PRIOR ART

Aircraft with propulsion that uses solely electrical power stored in batteries or other storage elements must have an electrical connection architecture capable of managing the flows of power from the storage elements to the electric motors, regardless of the conditions of use and any breakdowns.

The electrical power distribution networks on board most current aircraft, intended to supply power to the secondary circuits (ventilation, lighting, heating, etc.), generally comprise an AC network with alternating voltages of 115 V or 230 V for example, and/or a low voltage DC network of 28 V. The electrical powers involved generally range from 50 to 500 kW.

An aircraft with electric propulsion requires greater electrical power, and operates at higher direct voltages, of the order of 400 to 1000 V. For such aircraft with electric propulsion, it is necessary to define new electrical distribution architectures. Current research focuses on two distribution architecture topologies: segregated architectures and distributed architectures.

Segregated architectures comprise multiple electrically separate parallel distribution channels, each comprising a power bus connecting a power source to one or more respective motors.

In such an architecture, the loss of a power source inevitably leads to the loss of the associated motor(s). Depending on the type of aircraft and the type of propulsion system, it is possible for the system to include the possibility of redirecting the motor(s) toward a secondary backup power source, of the same type as the main source or of a different type (this is referred to as a hybrid architecture).

However, such a redundant system results in increased bulk and weight on board, because of the multiple connection buses and, where applicable, secondary sources which are not used in normal operation.

Distributed architectures seek to limit this problem of bulk and weight, which is particularly critical for use on an aircraft.

In this type of architecture, the sources are connected in parallel to a common power bus serving all the motors. In nominal mode, the voltages between the various batteries are balanced such that the batteries share the powering of the different loads. In the event of loss of a battery, the propulsion loads are powered by the remaining batteries.

This makes it possible to dimension the batteries as exactly as possible for nominal operation, and thus to optimize the weight of the batteries. The electrical power distribution network also becomes more integrated because the distribution bus associates multiple loads with multiple batteries.

A major drawback of distributed architectures concerns incident management, and in particular vulnerability to short circuits.

To be specific, in the event of a short circuit, a battery can deliver a current of several thousand amperes in a few milliseconds. When the batteries are connected in parallel on the network, this phenomenon is multiplied by the number of batteries in parallel.

The first, direct consequence is that the currents involved in this type of short circuit can be destructive for aeronautical components, and active protection solutions are not capable of isolating the fault.

The second consequence is linked to the nature of the distributed distribution architecture. To be specific, unlike a segregated distribution architecture, which does not propagate the consequences of a short circuit to the entire propulsion network, in this type of architecture, the network voltage received by all the motors will break down for a period long enough to cause unacceptable loss of propulsion of the aircraft, all the motors connected to the bus no longer being supplied with power owing to protection being put in place automatically linked to a bus voltage level that is too low.

### PRESENTATION OF THE INVENTION

The invention aims to overcome these drawbacks, by proposing an electrical propulsion network architecture allowing the propulsion loads to be taken over in the event of loss of one of the power sources, without excessive bulk and mitigating the risks associated with a distributed architecture.

To this end, the subject of the invention is an electrical propulsion system for an aircraft, the system comprising a plurality of branches, each branch comprising:
at least one electrical power source,
at least one electric propulsion device, and
a branch bus, connected to each source and to each propulsion device of the branch, characterized in that the propulsion system further comprises a central bus, each branch comprising a DC/DC voltage converter connecting the branch bus to the central bus, said DC/DC voltage converter being configured to galvanically isolate said branch bus from the central bus.

Such a system makes it possible to supply power to a plurality of electric motors for the propulsion of an aircraft, allowing the motors of one branch to be taken over in the event of failure of the corresponding power source, while being protected against the risk of propagation of short circuits.

The system may further comprise a backup electrical power source connected to the central bus.

Such a feature makes it possible to compensate for the loss of a power source in the event of a fault and thus maintain a sufficient voltage level in each propulsion device by distributing the voltage through the central bus.

Each propulsion device may be connected to one of the branch buses by a disconnection member.

Such a feature allows individual protection of the propulsion device against overcurrents.

Each branch bus may be connected to the central bus by:
a branch switching member of contactor type or of power semiconductor switch type, and
a diode having a passing direction oriented from the central bus toward the branch bus,
   the branch switching member and the diode being connected in series between the central bus and the branch bus, in parallel with the DC/DC voltage converter.

Such a feature makes it possible to redistribute some of the electrical power in each branch so as to power the propulsion devices of a branch having a faulty source, without risking return currents.

Each power source may be connected to the corresponding branch bus by a source switching member of contactor type or of power semiconductor switch type.

This feature makes it possible to isolate a faulty source with a view to restarting the branch.

The system may comprise a control circuit configured to implement a fault management method in the event of a fault in the system.

Such a feature makes it possible to protect the propulsion system against various incidents while maintaining optimal capacities depending on the scenario.

The invention also relates to a method for managing faults in an electrical propulsion system for aircraft as described above, comprising steps of:
preventing propagation of the fault by means of galvanic isolation implemented by each DC/DC voltage converter,
locating the fault and, if necessary, isolating a source or a propulsion device, and
where applicable, precharging then restarting propulsion devices which have stopped.

The method may include switching at least one source switching member and/or at least one branch switching member.

The method may include the opening of at least one disconnection member.

The invention also relates to an aircraft comprising an electrical propulsion system as described above.

### BRIEF DESCRIPTION OF THE FIGURES

FIG. 1 is a schematic view of an electrical propulsion system according to the invention,

FIGS. 2 to 4 show successive steps of a method for managing a fault in a source region of the propulsion system of FIG. 1,

FIGS. 5 to 7 show successive steps of a method for managing a fault in a bus region of the propulsion system of FIG. 1,

FIGS. 8 to 10 show successive steps of a method for managing a fault in a motor region of the propulsion system of FIG. 1, and

FIG. 11 shows a method for managing a fault in a central region of the propulsion system of FIG. 1.

### DETAILED DESCRIPTION OF THE INVENTION

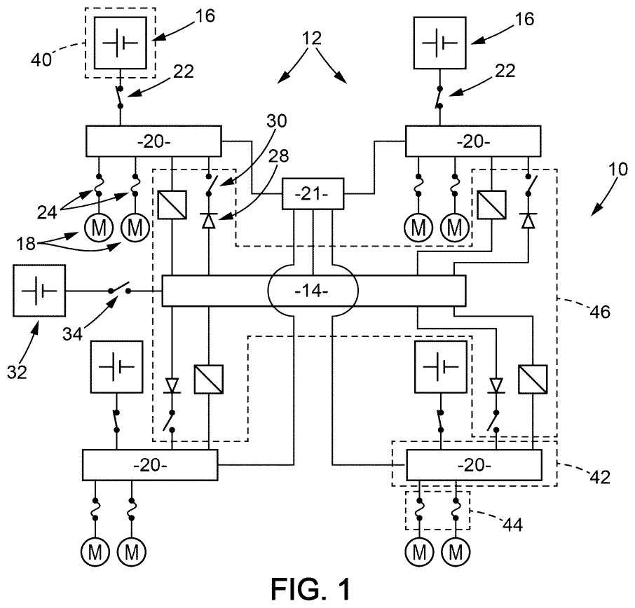

An electrical propulsion system 10 according to the invention is shown in FIG. 1. The propulsion system 10 is intended to propel an aircraft independently, in other words the aircraft has purely electric propulsion.

The propulsion system 10 comprises a plurality of branches 12, for example four branches 12 in the case shown, and a central bus 14.

Each branch comprises an electrical power source 16, at least one electric propulsion device 18 and a branch bus 20 connected to said source 16 and to each propulsion device 18.

The sources 16 are for example batteries on board the aircraft, which supply power to the primary electrical network, intended for propulsion.

The propulsion devices 18 are for example electric motors installed in turbomachines propelling the aircraft.

The central bus 14 and the branch buses 20 are devices for distributing electrical power between several components, under high voltage and direct current, installed in secure housings. They also include logic connectors connected to a control circuit 21.

Each source 16 is connected to the branch bus 20 by a protected electrical power line comprising a source switching member 22.

The source switching member 22 is for example of contactor type or of power semiconductor switch type. Such a switching member is adapted to switch even when an electric current of relatively high intensity is passing through it.

Each propulsion device 18 is connected to the corresponding branch bus 20 by a respective electrical power line, comprising a disconnection member 24, such as a thermal fuse. The disconnection member 24 is adapted to passively disconnect the propulsion device 18 from the branch bus 20 in the event of overcurrent passing through it, or in a manner controlled by the control device 21.

Each branch bus 20 is connected to the central bus 14 by a DC/DC voltage converter 26 and, arranged in parallel with said voltage converter 26, a diode 28 and a branch switching member 30.

The DC/DC voltage converter 26 is adapted to galvanically isolate the branch bus 20 from the main bus 14.

The diode 28 is arranged with a passing direction oriented from the central bus 14 toward the corresponding branch bus 20. The diode 28 and the branch switching member 30 together form a one-way electrical power transfer circuit, from the central bus 14 to the corresponding branch 12.

The branch switching member is open during normal operation of system 10.

The propulsion device 10 further comprises a backup source 32 connected to the central bus 14 by a backup switch 34.

The backup source 32 is configured to provide power in the event of failure of one of the sources 16, so as to compensate for the loss. The voltages in the various propulsion devices 18 are balanced through the central bus 14.

The control circuit 21 includes electronic boards and current and voltage sensors distributed throughout the propulsion system, in order to protect the entire network and to implement fault management methods described below.

To this end, four regions of the propulsion system 10 in which a fault may occur are defined.

A source region 40 includes the power sources 16 and the entire electrical power line upstream of the source switching member 22.

A bus region 42 includes the branch buses 20 and the lines for connection to the central bus 14.

A motor region 44 includes the lines for connection of the propulsion devices 18 to the associated branch bus 20.

Lastly, a central region 46 includes the central bus 14, the lines for connection of this central bus 14 to the branch buses 20, and the DC/DC voltage converters and the associated distribution circuits.

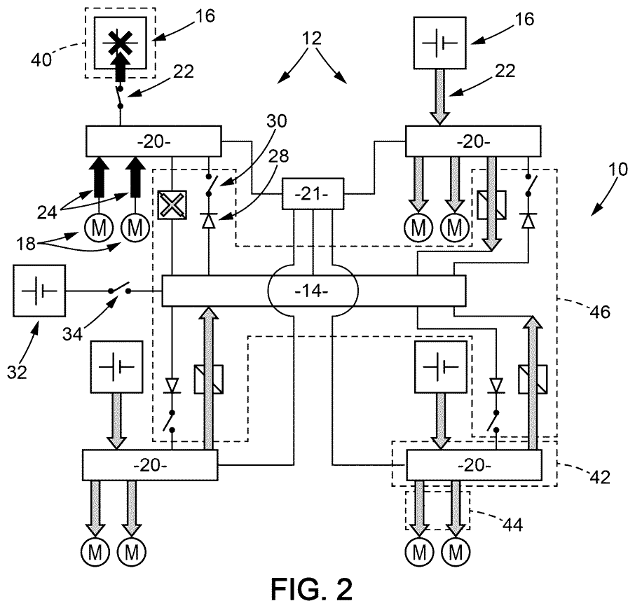

First, a method for managing a fault occurring in the source region 40 is described. In FIGS. 2 to 11, the gray arrows designate a normal current corresponding to standard operation of the system 10. The black arrows designate an abnormal current, in particular a short-circuit current, and the white arrows a correction current, put in place to compensate for faults in system 10.

The fault is for example a short circuit, which is powered by the source 16 of the branch 12 and the propulsion devices 18, which supply power through their input capacitances, as shown in FIG. 2.

By virtue of the galvanic isolation implemented by the DC/DC voltage converter 26 of the branch 12, only the source 16 of the branch powers the short circuit, the other branches 12 being isolated.

During a first step, the control circuit 21 detects the fault by means of the current and voltage sensors of the branch 12, and stops the regulation implemented by the DC/DC voltage converter 26, in order to stop the distribution of power in the propulsion devices 18 of the branch 12.

In parallel, these propulsion devices 18 of the branch 12 are also stopped for the time necessary to isolate the fault.

The operation of the other branches 12 continues unchanged, ensuring the propulsion of the aircraft.

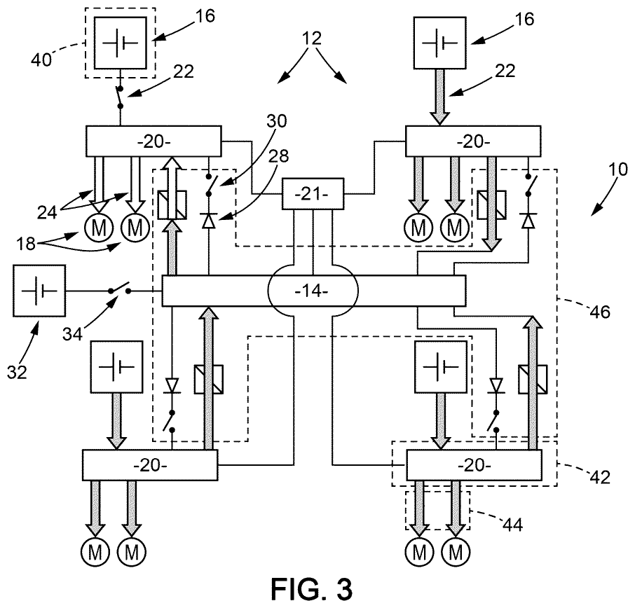

During a second step, shown in FIG. 3, the source 16 of the branch 12 is isolated by the switching of the associated source switching member 22 by the control circuit 21.

Once the fault has been isolated, the control circuit 21 restarts regulation by the DC/DC voltage converter 26 of the branch 12, in order to allow precharging of the propulsion devices 18.

To be specific, such precharging is necessary before restarting the propulsion devices 18, in which the voltage has dropped dramatically.

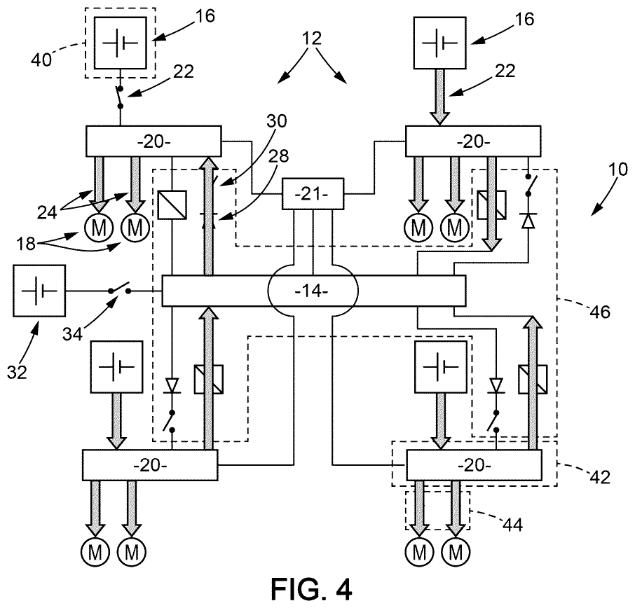

Lastly, once precharging is complete, the branch switching member 30 is closed in order to transmit power coming from the DC/DC voltage converters 26 of the other branches 12, to re-power the propulsion devices 18 of the faulty branch, as shown in FIG. 4.

The additional power delivered by each of the other branches 12 to power the propulsion devices 18 of the faulty branch is divided by the number of remaining branches, which reduces the individual load on each source 16.

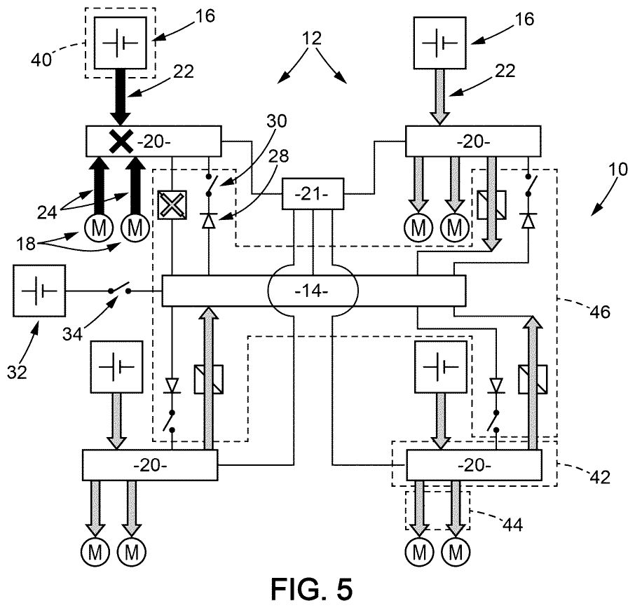

Second, a method for managing a fault occurring in the bus region 42, shown in FIG. 5, is described.

When an electrical fault occurs at a branch bus 20, the first consequence resulting from this fault is the increase in the current delivered by the source 16.

As before, the sources 16 and the input capacitances of the propulsion devices 18 deliver electrical power into the short circuit.

Just as in the previous case, the galvanic isolation of the DC/DC voltage converter 26 of the branch 12 makes it possible to prevent the propagation of the fault to the other branches 12.

The control circuit 21 detects the presence of a short circuit in the branch 12 by means of the current and voltage sensors, and stops the regulation implemented by the DC/DC voltage converter 26, in order to stop the distribution of power in the propulsion devices 18 of the branch 12.

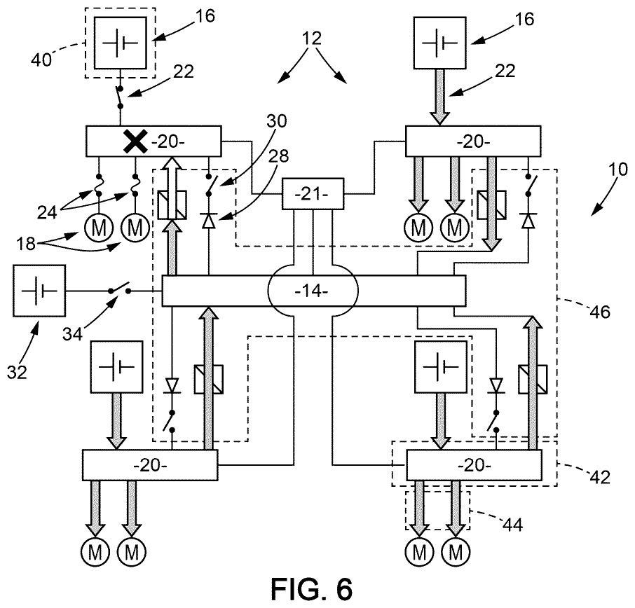

During a second step, shown in FIG. 6, the control circuit 21 isolates the source 16 to stop the flow of current in the short circuit, by switching the source switching member 22. In parallel, the set voltages of the propulsion devices 18 are set to zero.

In order to determine the location of the fault, the control circuit 21 begins a precharging sequence via the DC/DC voltage converter 26, as before. As the fault is located on the branch bus 20, precharging does not work and the voltage seen by the propulsion devices 18 does not increase sufficiently. During precharging, the galvanic isolation implemented by the DC/DC voltage converter 26 prevents any excessive current.

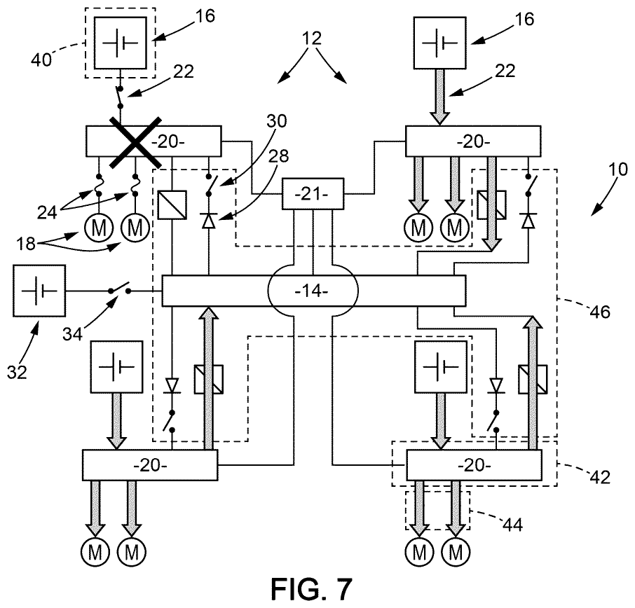

After a confirmation time, the control circuit determines that the fault is on the branch bus 20. The branch 12 is then isolated, as shown in FIG. 7, because it is impossible to restart the associated propulsion devices 18.

Third, a method for managing a fault occurring in the motor region 44 is described.

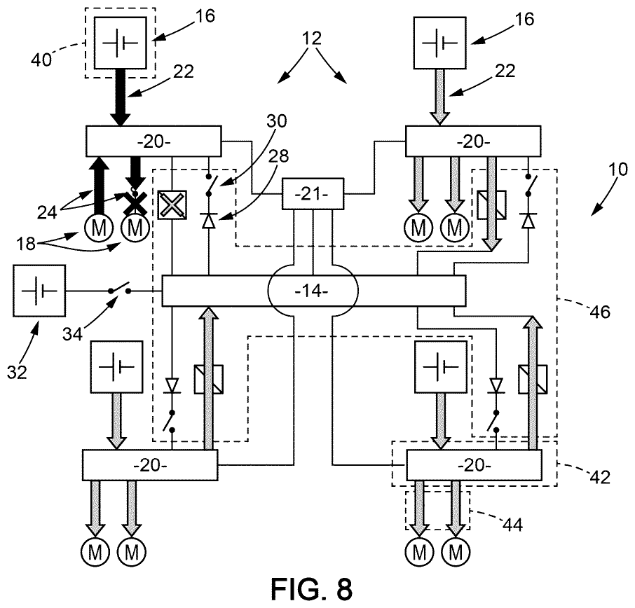

In this case, the occurrence of a fault in the power supply line of one of the propulsion devices 18 results in the occurrence of an overcurrent from the source 16 and the propulsion device 18 which is still functional, which empties its input capacitances into the short circuit, as shown in FIG. 8.

As in the previous cases, the galvanic isolation of the voltage converter 26 ensures that the short circuit is not propagated to the rest of the system 10.

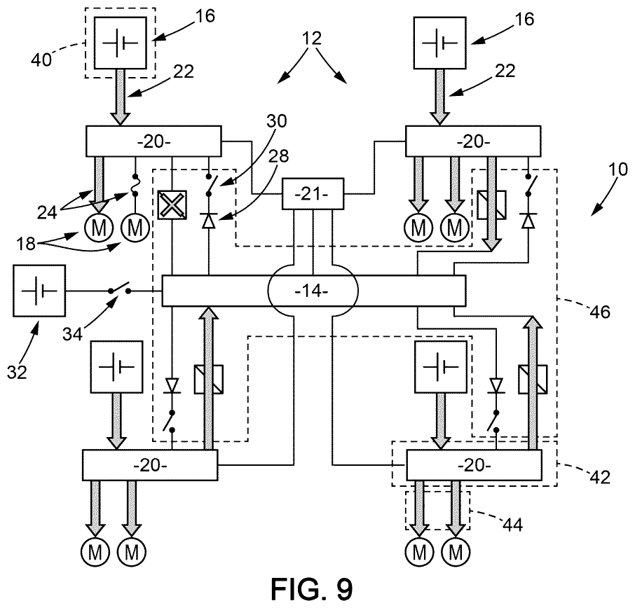

The current and voltage sensors allow the control circuit 21 to identify the faulty propulsion device 18 and isolate it from the network, by triggering the opening of the corresponding disconnection member 24, as shown in FIG. 9.

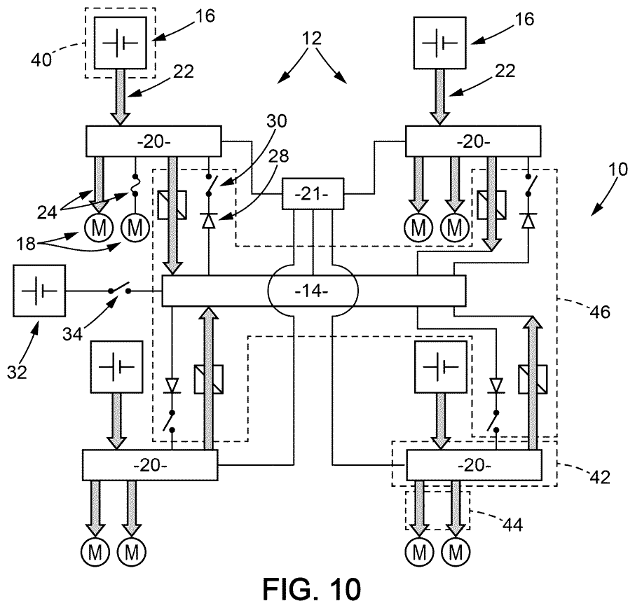

Once the disconnection member 24 is open, the source 16 may again supply electrical power to the remaining propulsion device 18 in the branch 12, as shown in FIG. 10.

Once the voltage returns to the correct level, the control circuit 21 restarts regulation by the DC/DC voltage converter 26.

Lastly, a method for managing a fault occurring in the central region 46 is described.

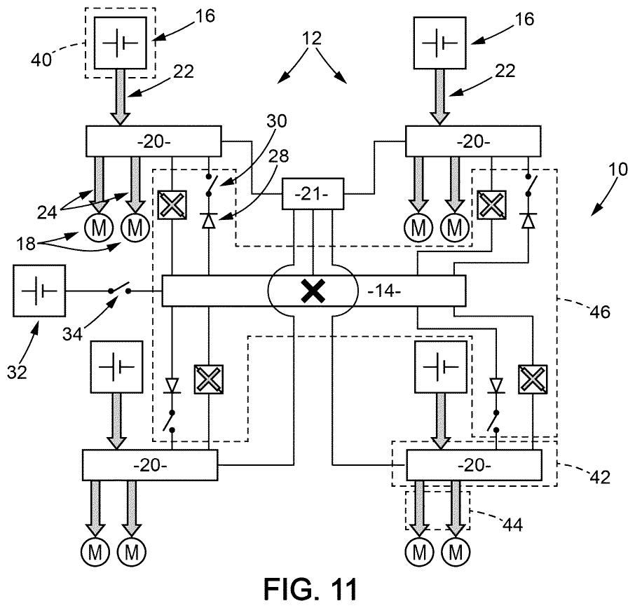

In the event of an electrical fault occurring on the central bus 14, the DC/DC voltage converters 26 stop their regulation. The control circuit 21 measures a significant drop in voltage at the output of each DC/DC voltage converter 26, thus saturating their regulations and going into dysfunctional mode, as shown in FIG. 11.

Once again, the galvanic isolation of each DC/DC voltage converter 26 ensures that the fault is not propagated to the branches 12, preventing the sources 16 from delivering current into the fault.

In this case, stopping the DC/DC voltage converters 26 is necessary and sufficient to isolate the fault.

The propulsion system 10 then operates like a conventional segregated architecture system, leaving sufficient power and time for the aircraft to land safely.

In the four cases of faults presented, the system retains its integrity and the propulsion devices remain functional, ensuring that the aircraft is able to carry out its mission. The architecture of the propulsion system 10 also makes it possible to do without protection against short-circuit currents dimensioned for the number of sources 16 on board. The presence of a DC/DC voltage converter 26 with galvanic isolation could result in a significant increase in weight, affecting the aircraft's capacity for flight. However, the architecture of the present invention minimizes this effect by making it possible to dimension the converters not on the basis of the actual power of each source, but rather on the basis of a reduced power, according to the number of sources present.

1. An electrical propulsion system (10) for an aircraft, comprising:
a plurality of branches (12), each branch (12) comprising:
at least one electrical power source (16),
at least one electric propulsion device (18), and
a branch bus (20), connected to each source (16) and to each propulsion device (18) of the branch (12), and
a central bus (14),
wherein each branch of the plurality of branches (12) comprises a DC/DC voltage converter (28) connecting the branch bus (20) to the central bus (14), said DC/DC voltage converter (28) being configured to galvanically isolate said branch bus (20) from the central bus (14).

2. The system (10) as recited in claim 1, further comprising a backup electrical power source (32) connected to the central bus (14).

3. The system (10) as recited in claim 1, wherein each propulsion device (18) is connected to the branch bus (20) by a disconnection member (24).

4. The system (10) as recited in claim 1, wherein each branch bus (20) is connected to the central bus (14) by:
a branch switching member (30) of contactor type or of power semiconductor switch type, and
a diode (28) having a passing direction oriented from the central bus (14) toward the branch bus (20),
the branch switching member (30) and the diode (28) being connected in series between the central bus (14) and the branch bus (20), in parallel with the DC/DC voltage converter (26).

5. The system (10) as recited in claim 1, wherein each source (16) is connected to the branch bus (20) by a source switching member (22) of contactor type or of power semiconductor switch type.

6. The system (10) as recited in claim 5, comprising a control circuit (31) configured to implement a fault management method in the event of a fault in the system (10).

7. A method for managing faults in an electrical propulsion system (10) for aircraft as recited in claim 1, comprising steps of:
preventing propagation of the fault by means of galvanic isolation implemented by each DC/DC voltage converter (26),
locating the fault and, if necessary, isolating a source (16) or a propulsion device (18), and
where applicable, precharging then restarting propulsion devices (18) which have stopped.

8. An aircraft comprising an electrical propulsion system as recited in claim 1.
